(19) United States
(12) Patent Application Publication
(10) Pub. No.: US 2005/0046168 A1
(43) Pub. Date: Mar. 3, 2005

(54) Safety belt with anti-submarine protection

(76) Inventor: Elwood Jesse Bill Simpson, Brownsburg, IN (US)

Correspondence Address: Woodard, Emhardt, Moriarty, McNett & Henry LLP;Bank One Center/Tower, 111 Monument Circle, Suite 3700, Indianapolis, IN, 46204-5137, US

(21) Appl. No.: 10/648,059

(22) Filed: Aug. 26, 2003

(51) Int. Cl. B60R 22/00

(52) U.S. Cl. 280/801.1

(57) ABSTRACT

The present invention relates to a safety belt with anti-submarine protection. The anti-submarine portion of the safety belt comprises two webbing portions that are coupled to a belt latching mechanism on one end and to a secure mounting location at the other end. The anti-submarine belts are positioned to traverse the seat occupant's groin area, with one of the belts positioned to either side of a male occupant's testicles. By positioning a pair of anti-submarine belts in this manner, the major portion of the anti-submarine belt's forward movement resistance force is applied to the occupant's pelvis to either side of the testicles, rather than to the testicles themselves, thereby substantially avoiding injury and severe discomfort. Furthermore, many male occupants find the anti-submarine belt of the present invention to be much more comfortable than the prior art belt even in non-accident times of use.

### TECHNICAL FIELD OF THE INVENTION

The present invention generally relates to safety belts used for vehicle occupants and, more particularly, to a safety belt with anti-submarine protection.

### BACKGROUND OF THE INVENTION

As is known in the art, safety belts are commonly used in vehicle interiors in order to limit movement of the belted occupant in the event of sudden vehicle movements, particularly accidents in which the car experiences a violent collision with another stationary or moving object. Because of the generally higher speeds and the competitive nature of the driving, safety belts for racing cars are generally designed for greater protection of the belted occupant than are safety belts for general vehicular use.

FIGS. 1 and 2 schematically illustrate a typical prior art racing safety belt, indicated generally at 10. A belted occupant and the associated vehicle seat are illustrated in phantom. The safety belt 10 comprises several sections of webbing material, such as typical nylon webbing material that is well-known in the art. The safety belt 10 includes lap belt webbing sections 12 and 14, each of which couple at one respective end to a latch and link mechanism 16 as is known in the art. The other respective ends of lap belts 12 and 14 are coupled to secure mounting locations 18 and 20, respectively, that serve to securely anchor the belts to the vehicle, as is known in the art. The safety belt 10 further includes shoulder belt webbing sections 22 and 24, each of which couple at one respective end to the latch and link mechanism 16. The other respective ends couple to secure mounting locations (only one of which, mounting location 26, is visible in the drawings). The shoulder belt webbing sections either traverse over the top of the occupant's seat back or traverse openings in the occupant's seat back formed therein for this purpose.

Test data has shown that back injuries can be sustained by the belted occupant as a result of the occupant's pelvis moving forward during a rear or oblique impact to the vehicle. Such injuries result from the shoulder and lap belt sections preventing substantial forward movement of the occupant, which can cause the occupant's body to “submarine” partially under the lap belt, causing significant stresses to the occupant's back. In order to counteract such submarining of the occupant's body under the lap belt sections, the prior art safety belt 10 includes an anti-submarine belt webbing section 28, which couples at one end to the latch and link mechanism 16 and at the other end to a secure mounting location 30. The anti-submarine belt 28 traverses an opening formed through the occupant's seat bottom formed therein for this purpose. Typically, the secure mounting location 30 will be chosen so as to allow the anti-submarine belt 28 to angle slightly to the rear of the vehicle, typically forming an approximately 10 degree angle to the vertical.

FIG. 3 illustrates a prior art mounting hardware member that serves to couple the anti-submarine belt 28 to the latch and link mechanism 16, and is illustrated generally at 32. Member 32 comprises a body portion 34 having a slot 36 formed therein for receiving one end of the anti-submarine belt 28 therethrough. Body portion 34 is coupled to a tang portion 38 having a slot 40 formed therein for coupling to the latch and link mechanism 16, as is known in the art. The slot 40 opening is oriented 90 degrees from the slot 36 opening.

The anti-submarine belt 28 serves to limit forward motion of the occupant's pelvis during rear and oblique impacts to the vehicle, thereby minimizing related back injuries. A major drawback of the prior art anti-submarine belt 28 is that it is located directly in front of a male occupant's testicles, causing a major portion of the anti-submarine belt's forward movement resistance force to be applied to the occupant's testicles, which can cause injury and severe discomfort. Furthermore, many male occupants find the anti-submarine belt 28 to be uncomfortable even in non-accident times of use. There is therefore a need for an alternative anti-submarine device that minimizes force applied to a male driver's testicles. The present invention is directed toward meeting this need.

### SUMMARY OF THE INVENTION

The present invention relates to a safety belt with anti-submarine protection. The anti-submarine portion of the safety belt comprises two webbing portions that are coupled to a belt latching mechanism on one end and to a secure mounting location at the other end. The anti-submarine belts are positioned to traverse the seat occupant's groin area, with one of the belts positioned to either side of a male occupant's testicles. By positioning a pair of anti-submarine belts in this manner, the major portion of the anti-submarine belt's forward movement resistance force is applied to the occupant's pelvis to either side of the testicles, rather than to the testicles themselves, thereby substantially avoiding injury and severe discomfort. Furthermore, many male occupants find the anti-submarine belt of the present invention to be much more comfortable than the prior art belt even in non-accident times of use. Further embodiments of the present invention are also disclosed.

In one embodiment of the present invention, a hardware member for a safety belt for protecting an occupant of a vehicle is disclosed, the hardware member comprising a tang portion having a tang longitudinal axis; and a body portion coupled to the tang portion, the body portion including a first elongated slot, a second elongated slot, and a third elongated slot formed therethrough; wherein the second slot includes a second slot longitudinal axis that is substantially perpendicular to the tang longitudinal axis; wherein the first slot includes a first slot longitudinal axis that is at a first angle to the second slot longitudinal axis; and wherein the third slot includes a third slot longitudinal axis that is at a second angle to the second slot longitudinal axis.

### BRIEF DESCRIPTION OF THE DRAWINGS

FIG. 1 is a schematic front view of a prior art safety belt installed upon a seat occupant.

FIG. 2 is a schematic side view of the prior art safety belt of FIG. 1.

FIG. 3 is a schematic front and partial side view of a prior art hardware member used to couple the prior art anti-submarine belt to a latch and link mechanism.

FIG. 4A is a schematic front and partial side view of a preferred embodiment hardware member of the present invention used to couple the anti-submarine belt of the present invention to a latch and link mechanism.

FIG. 4B is a schematic top view of the preferred embodiment hardware member of FIG. 4A.

FIG. 5 is a schematic front view of a preferred embodiment safety belt of the present invention installed upon a seat occupant.

### DETAILED DESCRIPTION OF THE PREFERRED EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is thereby intended, and alterations and modifications in the illustrated device, and further applications of the principles of the invention as illustrated therein are herein contemplated as would normally occur to one skilled in the art to which the invention relates.

The present invention provides for a safety belt for a vehicle occupant that provides anti-submarine protection for the belted occupant while substantially reducing or eliminating forces applied to the male occupants testicles during a collision. The present invention utilizes dual anti-submarine belts which are positioned to either side of a male occupant's testicles, as well as a novel hardware member for coupling the anti-submarine belts to the safety belt's latching system.

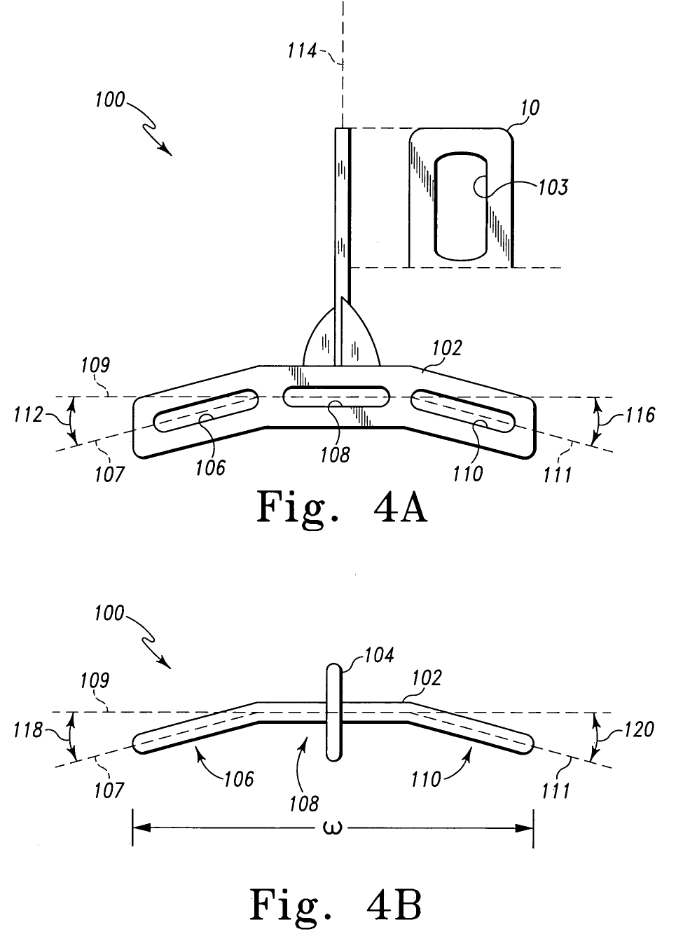

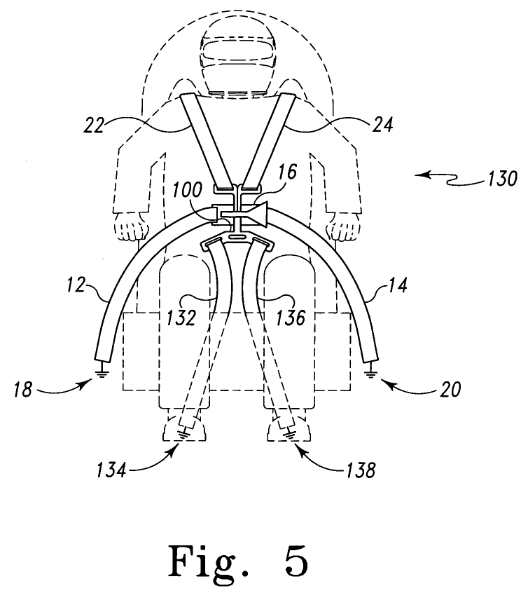

FIGS. 4A-B illustrate a preferred embodiment hardware member of the present invention, indicated generally at 100. The hardware member 100 includes a body portion 102 and an attached tang portion 104. Tang portion 104 has a slot 105 formed therein for coupling the hardware member to other hardware portions of the safety belt, as is known in the art. Body portion 102 preferably has three elongated slots 106, 108 and 110 formed therein. Slot 106 is configured to receive one end of a first anti-submarine belt (not shown—see FIG. 5) therethrough, while slot 110 is configured to receive one end of a second anti-submarine belt (not shown—see FIG. 5) therethrough. The slots 106-110 are preferably rounded in order to minimize bunching of the belt portions contained therein and to minimize wear thereon.

As shown in FIG. 4A, slot 106 has a longitudinal axis 107, slot 108 has a longitudinal axis 109, and slot 110 has a longitudinal axis 111. Furthermore, tang portion 104 has a longitudinal axis 114. The slot 108 longitudinal axis 109 is preferably formed at a substantially 90° angle to the tang portion 104 longitudinal axis 114. Slot 106 longitudinal axis 107 is preferably formed at an angle 112 to the slot 108 longitudinal axis 109, while the slot 110 longitudinal axis 111 is preferably formed at an angle 116 to the slot 108 longitudinal axis 109. The angles 112 and 116 are preferably, but not necessarily, the same and are preferably between about 5-40 degrees, more preferably between about 10-30 degrees, and most preferably between about 15-20 degrees.

As shown in FIG. 4B, the slot 106 longitudinal axis 107 is also formed at an angle 118 to the slot 108 longitudinal axis 109 in a plane that is orthogonal to the plane in which angles 112 and 116 lie. Similarly, the slot 110 longitudinal axis 111 is formed at an angle 120 to the slot 108 longitudinal axis 109 in this same plane. The angles 118 and 120 are preferably, but not necessarily, the same and are preferably between about 5-40 degrees, more preferably between about 10-30 degrees, and most preferably about 15 degrees.

Body portion 102 is coupled to a tang portion 104 having a slot 122 formed therein for coupling to a latch and link mechanism (not shown—see FIG. 5), as is known in the art. The slot 122 opening is preferably oriented 90 degrees from the slot 108 opening. The hardware member 100 may be made from any material that is suitably strong given the forces that member 100 may encounter in use, such as steel or forged aluminum, for example.

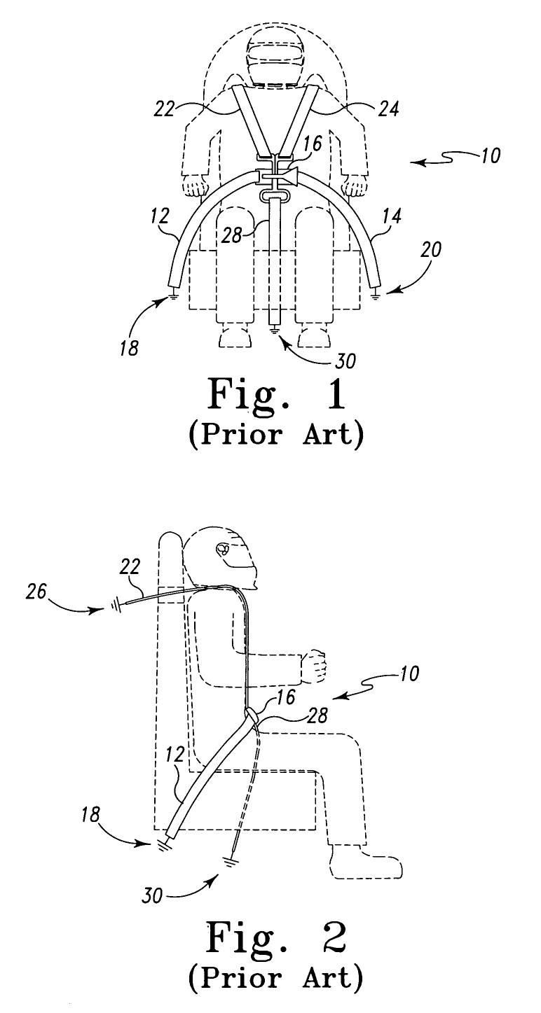

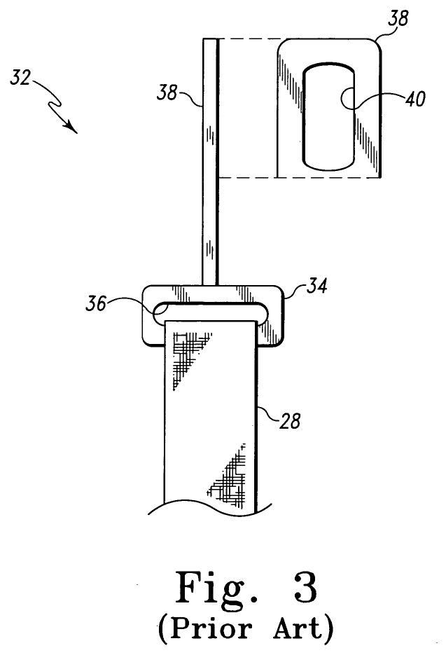

Referring now to FIG. 5, there is schematically illustrated a preferred embodiment safety belt of the present invention, indicated generally at 130. The safety belt 130 of the present invention shares several components with the prior art safety belt 10 of FIGS. 1 and 2, and like components are indicated with like numbers. The safety belt 130 includes lap belts 12 and 14, shoulder belts 22 and 24, and latch and link mechanism 16. Unlike the prior art safety belt 10, however, the safety belt 130 of the present invention includes a first anti-submarine belt webbing portion 132 that has a first end coupled through slot 106 of the hardware member 100 and a second end coupled to a secure mounting location 134. The safety belt 130 additionally includes a second anti-submarine belt webbing portion 136 that has a first end coupled through slot 110 of the hardware member 100 and a second end coupled to a secure mounting location 138.

The anti-submarine belts 132, 136 traverse a single slot or preferably two slots formed through the seat bottom for this purpose. If a single slot is used, it is preferred that the slot be elongated in order to allow the positions of the two anti-submarine belts to be separated. The slot(s) in the seat bottom are also preferably situated behind the male occupant's testicles, toward the rear of the vehicle.

As can be seen from a review of the preferred embodiment illustrated in FIGS. 4-5, the angles 112, 116, 118 and 120 formed into the hardware member 100 serve to position the ends of the anti-submarine belts 132 and 136 coupled thereto at a preferred attitude with respect to the seat occupant's groin area. This allows the belts to traverse the groin area to either side of the male occupant's testicles while being angled so as to pull away from the testicles when forced to apply pressure to the groin/pelvis area during a collision.

It will be appreciated from the above description that the safety belt of the present invention having dual anti-submarine belts represents a substantial improvement over the prior art designs. The safety belt of the present invention places a separate belt on either side of the male occupant's testicles, positioned to traverse the occupant's groin area, with one of the belts positioned to either side of the occupant's testicles. By positioning a pair of anti-submarine belts in this manner, the major portion of the anti-submarine belt's forward movement resistance force is applied to the occupant's pelvis to either side of the testicles, rather than to the testicles themselves, thereby substantially avoiding injury and severe discomfort. Furthermore, many male occupants find the anti-submarine belt of the present invention to be much more comfortable than the prior art belt, even in non-accident times of use.

The hardware member 100 is illustrated herein in a configuration adapted to mate to a prior art latch and link safety belt coupling mechanism. It will be appreciated by those having ordinary skill in the art that the hardware member and safety belt of the present invention may be used with any style of safety belt coupling mechanism, such as a camlock or other form of coupling mechanism, it only being necessary to modify the tang portion of the hardware member in order to allow it to engage the desired coupling mechanism in the usual way. Consequently, the present invention is not limited to applications using the latch and link coupling mechanism, and the appended claims which are not specifically directed to the latch and link configuration are intended to cover the use of the present invention with any desired type of coupling mechanism.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A hardware member for a safety belt for protecting an occupant of a vehicle, the hardware member comprising:
a tang portion having a tang longitudinal axis; and
a body portion coupled to the tang portion, the body portion including a first elongated slot, a second elongated slot, and a third elongated slot formed therethrough;
wherein the second slot includes a second slot longitudinal axis that is substantially perpendicular to the tang longitudinal axis;
wherein the first slot includes a first slot longitudinal axis that is at a first angle to the second slot longitudinal axis; and
wherein the third slot includes a third slot longitudinal axis that is at a second angle to the second slot longitudinal axis.
